(19) United States
(12) Patent Application Publication
(10) Pub. No.: US 2002/0044650 A1
(43) Pub. Date: Apr. 18, 2002

(54) Identity credence and method for producing the same

(75) Inventor: Ning Shen, Hangzhou (CN)

Correspondence Address: MERCHANT & GOULD PC, P.O. BOX 2903, MINNEAPOLIS, MN, 55402-0903, US

(73) Assignee: Miaxis Biometrics Co.

(21) Appl. No.: 09/911,325

(22) Filed: Jul. 23, 2001

(30) Foreign Application Priority Data
Aug. 24, 2000 (CN) 00126213.0

(51) Int. Cl. H04L 9/00

(52) U.S. Cl. 380/30; 713/180

(57) ABSTRACT

An identity credence and a method for producing the same are provided in the present invention. In order to produce the identity credence, the issuing organ firstly constructs a first information packet which comprises identity information and biometrics information; then selects an asymmetric encryption algorithm for digital ciphering on the first information packet with a private key to generate a second information packet; and finally stores the second information packet generated by ciphering into a medium to produce an identity credence.

### FIELD OF THE INVENTION

The present invention relates to an information encryption and authentication technique, and more particularly, it relates to an identity credence including digital biometrics information and its producing method.

### BACKGROUND OF THE INVENTION

At present, in China, it is the Ministry of Public Security that issues identity cards to citizens. In an identity card, various kinds of information are involved, such as figure, name, sex, nationality, date of birth, address, issuing date, term of validity, serial number and issuing organ. Such kinds of information are readable original information. They reflect the identity of the cardholder directly. The readability and intuitively of the information makes it convenient to authenticate the identity. More specifically, while authenticating the identity, it is only required to compare the figure on the identity card with the appearance of the cardholder. If they are coincident, the information on the identity card will justify the identity of the cardholder. However, such an identity card is very easy to be forged and counterfeited. For example, a new identity card may be forged by modifying any of the characters or digital information on the identity card, such as name, date of birth, or address. It is fully a subjective decision to determine whether the figure coincides with the appearance of the cardholder while authenticating the identity. Therefore, if the cardholder looks like the figure on the identity card very much, the holder may counterfeit the holder of this identity card with ease.

In order to overcome the disadvantages of the above identity card with respect to being easy to be forged and counterfeited, there has been a proposal to digitally process the identity information and then store it on a smart card. However, due to using a smart card, the cost for producing such an identity card will be rather high.

### SUMMARY OF THE INVENTION

An object of the present invention is to provide an identity credence, which has lower cost and is difficult to be forged or counterfeited.

Another object of the present invention is to provide a method for producing the above identity credence.

According to one aspect of the present invention, a method for producing an identity credence is provided. The method comprises the steps of: constructing a first information packet including identity credence information and biometrics information; selecting an asymmetric encryption algorithm and digitally ciphering the first information packet with a private key to generate a second information packet; and storing the second information packet, which is generated by ciphering, into a medium to produce the identity credence.

According to another aspect of the present invention, an identity credence is provided. The identity credence includes: a storage medium for storing a second information packet generated by digitally ciphering a first information packet with a private key of an unsymmetrical key algorithm thereon, wherein the first information packet includes identity credence information and biometrics information.

Because an asymmetric encryption algorithm is selected during the period of producing an identity credence of the present invention, two different keys are used for encrypting and decrypting respectively, and they can not be deduced from each other. Therefore, the second information packet, which is obtained by digitally ciphering with a private key, is a complete entirety. It can not be modified, disassembled, or spliced.

According to the present invention, while producing an identity credence, the private key used for ciphering is only known by the issuing organ, and while authenticating the identity card, a terminal authenticating device is used to digitally authenticate the second information packet. That is, it is required to confirm whether the second information packet is generated by ciphering with a private key by the issuing organ. Therefore, this identity credence can not be forged by anybody.

Furthermore, while authenticating an identity credence, a terminal authenticating device is used to authenticate biometrics information of the second information packet. Therefore, this identity credence can not be counterfeited by anybody.

A common memory-contained IC card may be used as a storage medium for the identity credence of the present invention. Its cost is significantly lowered by comparing with microprocess smart card-type identity cards. Furthermore, the identity credence of the present invention may be duplicated at will without affecting the safety.

### BRIEF DESCRIPTION OF THE DRAWINGS

The present invention will be described in detail with reference to the accompanying drawings, wherein:

FIG. 1 is a flowchart showing the procedure of producing an identity credence according to the present invention.

FIG. 2 is a flowchart showing the procedure of authenticating an identity credence according to the present invention.

### DETAILED DESCRIPTION OF THE INVENTION

First, the procedure of producing an identity credence according to the present invention will be described.

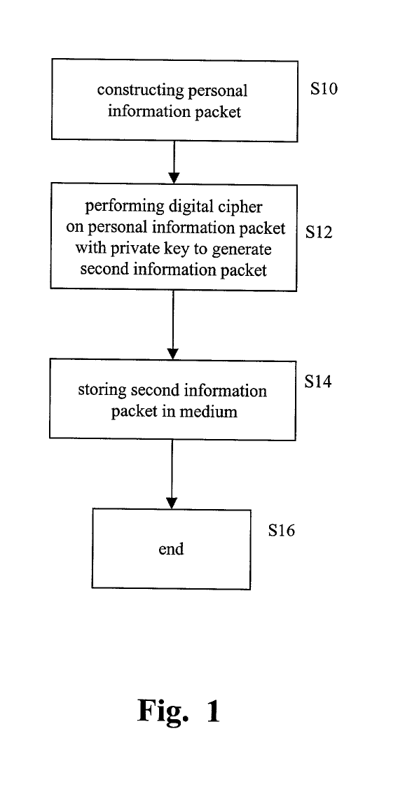

As shown in FIG.1, in Step S10, a personal information packet is constructed by an issuing organ for each applicant of an identity credence. The personal information packet includes two types of information: one type is identity credence information, such as name, sex, nationality, date of birth, address, issuing date, term of validity, serial number, and issuing organ; and the other type is biometrics information, such as fingerprint, iris, face, voice, and hand geometry. In Step S12, the issuing organ uses an asymmetric encryption algorithm to generate a second information packet by digitally ciphering the personal information packet with a private key. For example, digitally ciphering may be implemented by either digital encryption or digital signature. When the personal information packet is digitally encrypted with a private key, the second information packet is the information obtained by encrypting the personal information packet. When digital signature is performed on the personal information packet with a private key, the second information packet includes both the personal information packet and the digital signature. In Step S14, the second information packet generated by ciphering is stored into a medium, and the production of the identity credence is completed.

In a preferred embodiment of the present invention, the asymmetric encryption may be the RSA (Rivest-Shamir-Adleman) algorithm. So-called digital ciphering may be realized by either digital encryption or digital signature. The medium for storing the second information packet may be an IC card, a floppy disk, or a network database, etc.

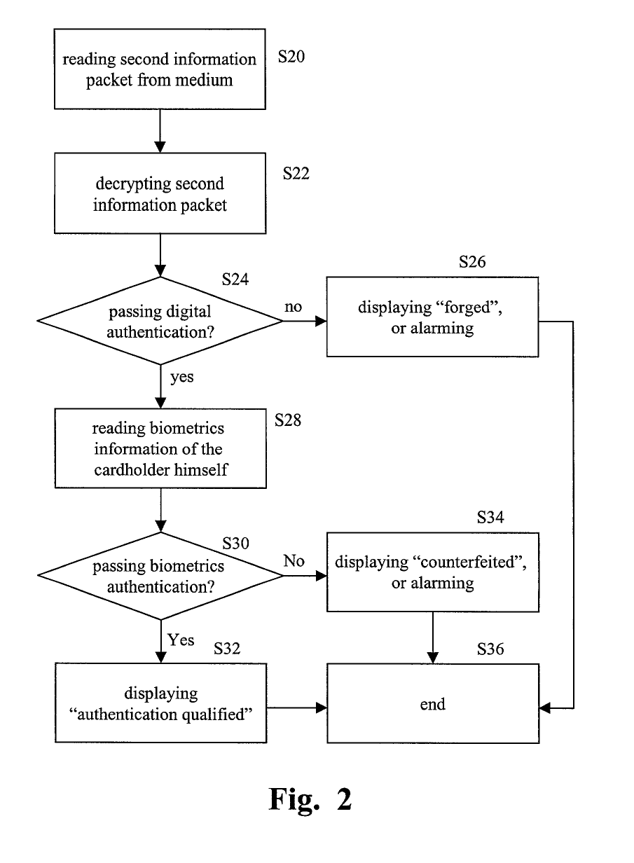

Next, referring to FIG. 2, the procedure for authenticating an identity credence of the present invention will be described. In Step S20, the second information packet stored in the medium is read out by an identity credence authenticating device. In Step S22, the second information packet is decrypted by the authenticating device with a public key. In Step S24, it is authenticated whether the second information packet is obtained by digitally encrypting or performing digital signature by the issuing organ with the private key or not. If the authentication result of is negative, then the procedure goes to Step S26 in which “Identity credence is forged” will be displayed on a display screen, and alternatively an acoustic alarm may be established to indicate that the identity credence is forged. Then the authentication procedure is ended. If the authentication result in Step S24 is positive, the procedure goes to Step S28. In Step S28, biometrics information of the cardholder himself, such as fingerprint, iris, eyeground, or palm print, will be read out by the authenticating device. In Step S30, the features of the biometrics information read out by the authenticating device are compared with those obtained by decrypting the second information packet, and whether the two sets of biometrics information are coincident or not is decided. If the two sets of biometrics information are coincident, the procedure goes to Step S32 in which “Authentication is qualified” will be displayed on the display screen of the authenticating device, and then the procedure is ended. If the two sets of biometrics information are not coincident, the procedure goes to Step S34 in which “Identity credence is counterfeited” will be displayed on the display screen of the authenticating device, and alternatively an acoustic alarm may be established to indicate that the identity credence is counterfeited. Then the authentication procedure is ended.

Evidently, in the procedure for authenticating an identity credence as described above, the order of the digital authentication procedure and the biometrics information authentication procedure can be exchanged.

In order to describe the present invention more clearly, two preferred embodiments will be described below as examples.

### Embodiment 1

### IC card-type Fingerprint Identity Card

In this embodiment, the identity credence of the present invention is applied to an identity card. A personal information packet, which is constructed by the Ministry of Public Security for each citizen, is listed in the following tables, wherein biometrics information includes the fingerprints of four fingers of a right hand.

Identity Information

| Information | | |
|---|---|---|
| Item | Information Content | Storage Space |
| Name | 10 Chinese characters | 20 bytes |
| Sex | Indicating male or female | 1 byte |
| | using the number 1 or 0 | |
| Nationality | Indicating 56 nationalities | 1 byte |
| | using the number 1-56 | |
| Date of birth | 8 digits | 4 bytes |
| Address | 25 Chinese characters | 50 bytes |
| Issuing date | 8 digits | 4 bytes |
| Term of validity | 8 digits | 4 bytes |
| Serial number | 24 digits | Storing 24 bytes |
| Issuing organ | 20 Chinese characters | 40 bytes |
| Card number | 20 digits | 20 bytes |

Fingerprint Information

| Information | | |
|---|---|---|
| Item | Information Content | Storage Space |
| Fingerprint | Fingerprint of index finger of | 256 bytes |
| template 1 | right hand | |
| Fingerprint | Fingerprint of middle finger | 256 bytes |
| template 2 | of right hand | |
| Fingerprint | Fingerprint of ring finger of | 256 bytes |
| template 3 | right hand | |
| Fingerprint | Fingerprint of little finger of | 256 bytes |
| template 4 | right hand | |

The Ministry of Public Security selects RSA algorithm and performs digital signature on the above personal information packet with a private key A to generate a second information packet. At this time, both the personal information packet and the digital signature are involved in the second information packet. Then, the second information packet is stored into a memory-contained IC card, and a fingerprint identity card is produced in the form of an IC card and issued to the applicant.

When a cardholder uses the identity card according to the present invention, he shall insert the identity card into an off-line authenticating device for IC card-type fingerprint identity card, and put four fingers of his right hand on the fingerprint reader section of the authenticating device. The authenticating device performs digital signature on the second information packet stored in the IC card with a public key B, and authenticates the fingerprint information in the second information packet with the fingerprint information read out by the fingerprint reader section. If both the digital signature authentication and the fingerprint authentication are qualified, the identity of the cardholder is authenticated.

The following are the advantages involved in the above IC card-type fingerprint identity card:

First, because the RSA encryption algorithm selected by the Ministry of Public Security during the procedure for producing the identity card is an asymmetric encryption, so the encryption key A and the encryption key B are different, and A and B can not be deduced from each other. Therefore, the second information packet, which is obtained by digitally signature with a private key, is a complete entirety. It can not be modified, disassembled, or spliced.

Second, the private key of the RSA algorithm is only known by the Ministry of Public Security. Also, while authenticating the identity card, it is needed to use an off-line type authenticating device for an IC card-type fingerprint identity card to perform digital signature on the second information packet, i.e., to confirm whether the second information packet is obtained by performing digital signature with the private key A by the Ministry of Public Security or not. Therefore, the identity card can not be forged by anybody.

Third, while authenticating the identity card, it is required to use the off-line type authenticating device for the IC card-type fingerprint identity card to perform fingerprint authentication on the second information packet. Therefore, the identity card can not be counterfeited by anybody.

Fourth, because a common memory-contained IC card is used as the storage medium, so the cost is low. Comparing with microprocess smart card-type identity cards, the cost is lowered significantly.

Fifth, such identity cards can be duplicated at will without affecting the safety.

### Embodiment 2

### Employee's Card

In this embodiment, the identity credence of the present invention is applied to a company employee's card. A personal information packet, which is established by a personnel department of a company for each staff member, is listed in the following tables, in which biometrics information includes the fingerprints of four fingers of a the right hand.

Identity Information

| Information | | |
|---|---|---|
| Item | Information Content | Storage Space |
| Name | 20 alphabets | 20 bytes |
| Sex | Indicating male or female | 1 byte |
| | using the number 1 or 0 | |
| Position | 20 alphabets | 20 bytes |
| Date of birth | 8 digits | 4 bytes |
| Address | 50 alphabets | 50 bytes |
| Issuing Date | 8 digits | 4 bytes |
| Term of Validity | 8 digits | 4 bytes |
| Serial Number | 24 digits | 24 bytes |
| Issuing Unit | 40 alphabets | 40 bytes |
| Card Number | 20 digits | 20 bytes |

Fingerprint Information

| Information | | |
|---|---|---|
| Item | Information Content | Storage Space |
| Fingerprint | Fingerprint of index finger of | 256 bytes |
| template 1 | right hand | |
| Fingerprint | Fingerprint of middle finger of | 256 bytes |
| template 2 | right hand | |
| Fingerprint | Fingerprint of ring finger of | 256 bytes |
| template 3 | right hand | |
| Fingerprint | Fingerprint of little finger of | 256 bytes |
| template 4 | right hand | |

The personnel department of the company selects the RSA algorithm and encrypt the above personal information packet with a private key A to generate a second information packet. At this time, the second information packet is the information obtained by encrypting the above personal information packet. Then, the second information packet is stored in a disk and an employee's card is produced.

When a company staff member use an employee's card of the present invention, he shall insert the disk-type employee's card into a computer and put four fingers of his right hand on a fingerprint reader device connecting with the computer. The computer performs digital authentication on the second information packet stored in the disk with a public key B, and performs fingerprint authentication on the fingerprint information in the second information packet with those read out by the fingerprint reader device. If both the digital authentication and the fingerprint authentication are qualified, the identity of the cardholder is authenticated.

The employee's card of the present invention also has the advantages of the IC card-type fingerprint identity card as described above.

It will be apparent to those skilled in the art that, though in the preferred embodiments, the carrier of the identity credence is an IC card or a disk, the present invention is not intended to be limited to those. The second information packet may be stored in a medium such as a network database for providing the convenience in carrying and transferring. Although in the preferred embodiments, the RSA algorithm is used by the issuing organ to encrypt or perform digital signature on the personal information packet, the present invention is not intended to be limited to those. Other forms of asymmetric encryptions, such as Pohlig-Hellman algorithm, Rabin algorithm, ElGamal algorithm, or PGP algorithm, can also be used by the issuing organ to encrypt. Furthermore, the number of information items in the personal information packet can be increased or decreased as desired, while the information content and the storage space can be changed at one's desire. Biometrics information may not limited to be the fingerprint. It may also be the iris, eyeground, or palm print. In the preferred embodiments of the present invention, four fingerprint templates are included in the biometrics information, but the number of the templates of the present invention is not limited to four. The issuing organ may use only one fingerprint template. However, in this case, if the corresponding finger of the cardholder is hurt, it will be disable to obtain the feature of the finger. The fingerprint authentication will be problematical. If fingerprint information consists of several fingerprint templates, even when a certain finger is hurt, the remaining fingerprint templates can still be used to perform the fingerprint authentication. Similarly, when the iris, face, voice or hand geometry are used as biometrics information, one or a plurality of information templates can be used as well.

It should be appreciated for those skilled in the art that changes may be made without departing from the scope and spirit of the present invention. The scope of the present invention is defined by the appended claims.

What is claimed:

1. A method for producing an identity credence, characterized in that said method comprises the steps of:
constructing a first information packet which comprises identity credence information and biometrics information;
selecting an asymmetric encryption, and digitally ciphering said first information packet with a private key to generate a second information packet; and
storing said second information packet generated by ciphering into a medium to produce said identity credence.

2. A method according to claim 1, wherein said step of digitally ciphering said first information packet with said private key comprises the step of encrypting said first information packet with said private key to generate said second information packet, and wherein said second information packet includes the encrypted first information packet.

3. A method according to claim 1, wherein said step of digitally ciphering said first information packet with said private key comprises the step of performing digital signature on said first information packet with said private key to generate said second information packet, and wherein said second information packet includes both said first information packet and said digital signature.

4. A method according to claim 1, wherein said biometrics information is fingerprint information, eye iris information, eyeground information, or palm print information.

5. A method according to claim 1, wherein said asymmetric encryption is RSA algorithm, Pohlig-Hellman algorithm, Rabin algorithm, ElGamal algorithm, or PGP algorithm.

6. A method according to claim 1, wherein said medium is an IC card, a disk, or a network database.

7. A method according to claim 1, wherein said biometrics information includes a plurality of information templates.

8. An identity credence, characterized in that, said identity credence comprises:
a storage medium for storing a second information packet which is generated by digitally ciphering on a first information packet with a private key of an asymmetric encryption algorithm, wherein said first information packet includes identity information and biometrics information.

9. An identity credence according to claim 8, wherein said second information packet includes the information generated by encrypting said first information packet with said private key.

10. An identity credence according to claim 8, wherein said second information packet includes said first information packet and a digital signature which is generated by performing digital signature on said first information packet with said private key.

11. An identity credence according to claim 8, wherein said biometrics information is fingerprint information, iris information, eyeground information or palm print information.

12. An identity credence according to claim 8, wherein said asymmetric encryption algorithm is RSA algorithm, Pohlig-Hellman algorithm, Rabin algorithm, ElGamal algorithm, or PGP algorithm.

13. An identity credence according to claim 8, wherein said storage medium is an IC card, a disk, or a network database.

14. An identity credence according to claim 8, wherein said biometrics information includes a plurality of the information templates.
